(19) United States
(12) Patent Application Publication
(10) Pub. No.: US 2007/0012822 A1
(43) Pub. Date: Jan. 18, 2007

(54) Infant seat bottle holder

(76) Inventors: Elaine R. Bellamy-Noseworthy, Staten Island, NY (US); Michael J. Noseworthy, Staten Island, NY (US)

Correspondence Address: Raymond M. Galasso;Galasso & Associates LP, P.O. Box 26503, Austin, TX, 78755-0503, US

(21) Appl. No.: 11/192,466

(22) Filed: Jul. 18, 2005

(51) Int. Cl. A61J 9/06

(52) U.S. Cl. 248/104; 248/102

(57) ABSTRACT

An infant bottle holder designed to be attached to a carrier arm of an infant seat, such as a car seat, for feeding an infant while the infant occupies the seat. The infant bottle holder includes a bottle support member configured with retaining straps for securing a baby bottle. A support arm is present having two ends and an attachment member for securing the infant bottle holder to a carrier arm of a car seat. The attachment member has integrally formed therewith a hook utilized to support a child's toy.

### FIELD OF THE INVENTION

The present invention relates to a device for feeding an infant, and more specifically but not by way of limitation, a baby bottle holder that is designed to be suspended from a handle of an infant seat, such as an infant car seat, in order to support a baby bottle in the proper feeding position for the infant occupying the seat.

### BACKGROUND

Traveling with infants can be a very demanding task. During long trips or even while driving short distances infants often need to be fed. Unless there is another person in addition to the driver, in order to fulfill the demands of the hungry infant, the driver must find a suitable location to stop the vehicle and feed the infant. This issue presents several problems. An unhappy infant can create a significant disruption to distract the driver and thus increase the potential for accident. Also, if there is not a suitable location to pull the vehicle off the road to feed the child, the driver may be forced to feed the child on the side of the road, which again increases the likelihood of an accident.

Infants also need constant interaction and stimulation. Riding in the back seat of a vehicle can create a sensory deprivation zone. Having the ability to not only feed the infant but also have that device contain or have the ability to retain a toy would help keep the child entertained while in the car.

Another problem arises when having to stop the vehicle to feed the child. As time is a valuable resource, a device that can assist the driver in these situations would be very helpful.

Accordingly, there is a need for a infant bottle holder that can be suspended from the carrier arm of an infant seat that will allow the parent to place a bottle of desired liquid in the device and also have the ability to suspend a toy from this device to help feed and entertain the child during the for select periods of time such as during the driving process.

### SUMMARY OF THE INVENTION

It is an object of the present invention to provide a baby bottle holder which can be releasably attached to the carrier arm of an infant seat in order to assist in the feeding process while an infant occupies the seat, such as when the seat is secured in a vehicle.

It is another object of the present invention to provide a baby bottle holder which can be readily attached to an infant car seat that also includes a mechanism for securing an infant toy.

Yet another object of the present invention is to provide a baby bottle holder that is attached to an infant car seat that is relatively lightweight.

A further object of the present invention is to provide a baby bottle holder, which can be releasably attached to the carrier arm of an infant car seat that is compact.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 illustrates a perspective view of an embodiment of the present invention;

FIG. 2 illustrates a perspective view of an alternative embodiment of the present invention; and

FIG. 3 illustrates a side perspective view of an embodiment of the present invention connected to a handle of an infant seat.

### DETAILED DESCRIPTION

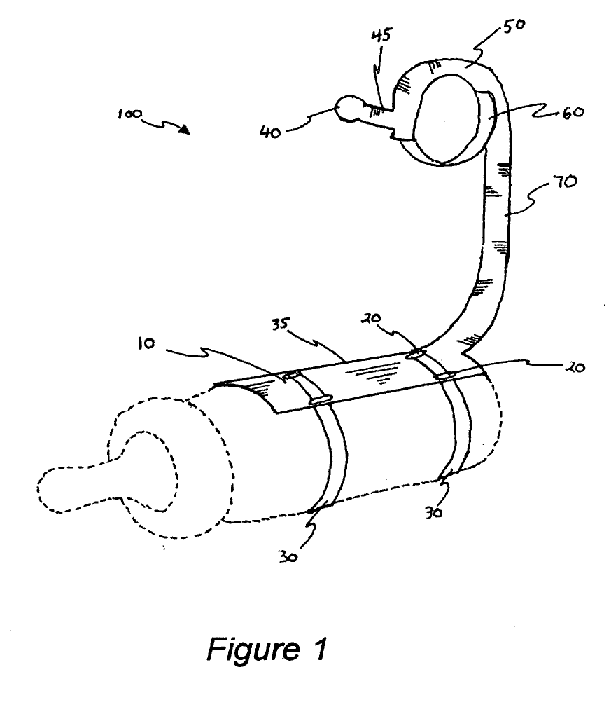

Referring now to the drawings, wherein various elements depicted are not necessarily drawn to scale, and in particular FIG. 1, there is illustrated a baby bottle holder 100 constructed according to the principles of the present invention

The baby bottle holder 100 comprises a bottle support member 10 being configured to securely mate with a baby bottle. The bottle support member 10 is relatively thin being generally less than one-quarter of an inch in thickness and has the approximate width of no more than one and a half inches. Although no specific dimensions are required good results have been shown in the present invention with a bottle support member 10 that is approximately six inches in length.

Proximate to the peripheral edge 35 generally parallel with each other are a pair of retaining apertures 20. The retaining apertures 20 are elongated slots that are of sufficient size to accommodate the retaining straps 30. The retaining apertures 20 are positioned peripherally on opposing sides of the bottle support member 10. A retaining strap 30 extends through a retaining aperture 20 on one side of the bottle support member 10 and extends above the bottle support member 10. Retaining strap 30 further extends through an opposing retaining aperture 20 on the opposite peripheral edge 35. The retaining straps 30 are substantially perpendicular with the bottle support member 10. The retaining straps 30 are hook/loop fastener straps that are of sufficient length to be completely circumferentially disposed around a standard baby bottle. Although it is not shown it is contemplated within the scope of this invention that numerous different materials could be used in place of and/or in conjunction with the material suggested herein for the retaining straps 30. More specifically but not by way of limitation, the retaining straps 30 could be manufactured from rubber, cloth, resilient metal or other suitable material. Those skilled in the art will recognize that these and other materials could be used to achieve the functionality suggested herein of the retaining straps 30. Although the preferred embodiment as shown in FIG. 1 illustrates two retaining straps 30 those skilled in the art will also recognize that one or more retaining straps 30 could be used to achieve the desired function suggested herein.

Still referring to FIG. 1, a generally planar support arm 70 extends from and is integrated with bottle support member 10. Although it is contemplated that the length of support arm 70 can be made of various lengths to accommodate various sizes of infants seats, good results have been shown to be achieved with a support arm 70 that is approximately seven inches in length. Numerous configurations of the support arm 70 are possible. More specifically but not by way of limitation, the support arm 70 could consist of two pieces that interconnect at a plurality of different points in order to make the support arm 70 adjustable.

The distal end of the support arm 70 is generally arcuate in shape to form an attachment member 50. The attachment member 50 is substantially perpendicular to the support arm 70 and generally parallel with the bottle support member 10. The attachment member 50 is of sufficient size to be integrated with a carrier arm of an infant car seat. As can be appreciated, attachment member 50 is configured to mate with the shape of the handle upon which it is to be placed.

It is contemplated within the scope of this invention that numerous configurations of the attachment member 50 are possible. More specifically but not by way of limitation, the attachment member 50 could be configured to integrate with infant car seats that do not have a carrier arm. Furthermore the attachment member 50 could also be configured to be mounted on the back seat of the vehicle adjacent to the infant car seat. Those skilled in the art will recognize the numerous configurations are possible for the attachment member 50 to achieve the functionality suggested herein.

Connected to attachment member 50 is fastener 60. Fastener 60 is a flexible strap, having a first end and a second end, which releasably secures the attachment member 50 to the carrier arm of the infant car seat. The first end of the fastener 60 is integrally mounted by conventional methods to the attachment member 50. The second end of the fastener is used to surroundably secure the attachment member 50 to an infant seat carrier handle. The fastener 60 is of sufficient length to completely encircle a carrier arm of an infant seat. The fastener 60 is manufactured from suitable materials such as but not limited to hook/loop fasteners. Those skilled in the art will recognize that other materials could be used in place of Hook/loop fastener for the fastener 60. More specifically but not by way of limitation, the fastener 60 could be manufactured from rubber or a resilient metal to achieve the suggested function of the fastener 60 as described herein.

Adjacent to the attachment member 50 opposite the second end of the support arm 70, and integrally formed therewith is a hook 45. The hook 45 is generally flat and rectangular in shape and of sufficient size to accommodate a child's toy. Although good results have been shown with a generally flat-shaped hook 45, those skilled in the art will recognize that many different shapes of the hook 45 are possible to achieve the functionality suggested herein. The hook 45 has a first end proximate to the attachment member 50 and a second end. Integrally formed thereon the second end of the hook 45 is a keeper 40. The keeper 40 is knob-shaped and is designed to retain articles on the hook 45 from falling off. Although the keeper 40 is shown to be generally knob-shaped, those skilled in the art will recognize that many different shapes and sizes could be used in place of and/or in conjunction with the keeper 45 as shown to achieve the desired function described herein.

Still referring to FIG. 1, the baby bottle holder 100 as shown in the preferred embodiment is constructed of thermoplastic. As is known to those skilled in the art, a thermoplastic is a high polymer that softens when exposed to heat and returns to its original condition when cooled to room temperature. Suitable thermoplastics include but are not limited to, nylon, polystyrene, polypropylene, and acrylic resins. It is preferred that the thermoplastic material be one that can be readily injection molded and is non-toxic. Thermoplastics also provide the opportunity to use a variety of different colors to manufacture the baby bottle holder 100. More specifically but not by way of limitation, the baby bottle holder 100 could be blue or pink. Although good results have been shown with thermoplastics those skilled in the art will recognize that many different materials could be used in place of and/or in conjunction with thermoplastic. More specifically but not by way of limitation, the baby bottle holder 100 could be manufactured from a rubber-coated resilient metal.

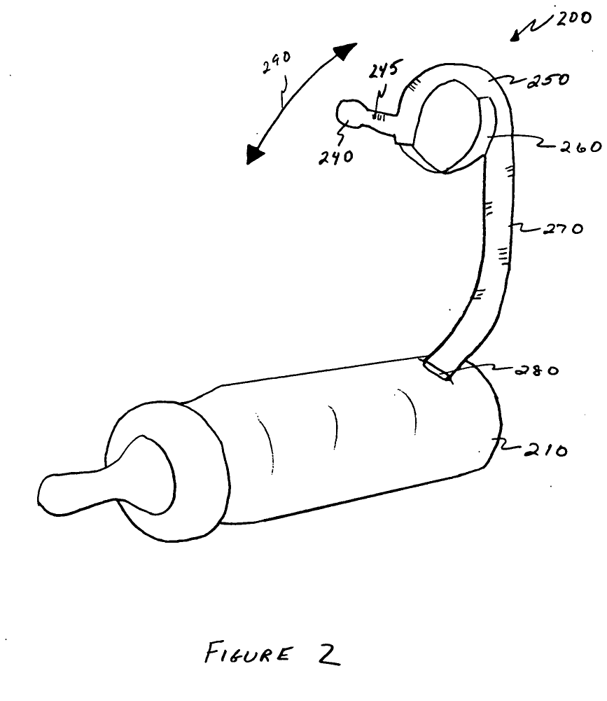

Referring now to FIG. 2, there is illustrated an alternative embodiment of a bottle holder 200. A bottle 210 is attached to support arm 270 with a hinge 280. Hinge 280 permits support arm 270 to be folded down (arrow 290) onto bottle 210 for storage and transport and then unfolded for attachment to the infant seat. As similarly described herein above with reference to FIG. 1, support arm is connected to attachment member 250 with a fastener 260 extending from attachment member 250. A hook 245 extends from attachment member 250 and includes a keeper 240.

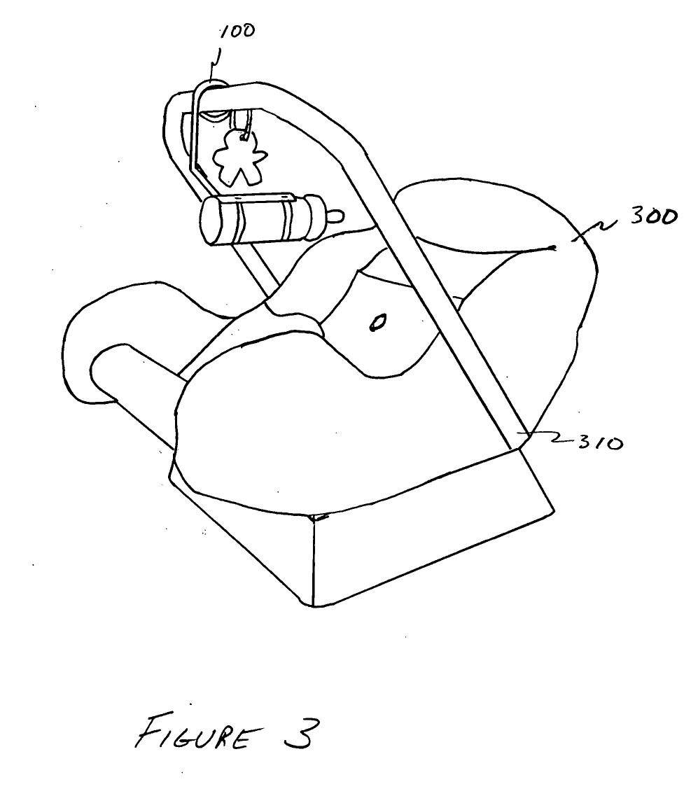

Referring now to FIG. 3, there is illustrated an infant car seat 300 with a carrying handle 310. Bottle holder 100 (described in detail herein above with reference to FIG. 1) is attached to the handle 310 of infant car seat 300. Although FIG. 3 illustrates the utilization of bottle holder 100, it is contemplated that any of the embodiments of the present invention described herein could be utilized. Additionally, bottle holders 100 and 200 can be used with virtually any infant seat that has a handle or other type of mechanism to properly hang the bottle holders in front of the infant, such as a seat is in a stroller or an infant seat, which is manually carried by an individual.

Referring in particular to the drawings submitted herewith, more specifically FIGS. 1 and 3, a description of the operation of the baby bottle holder 100 is as follows. In use, the user will place a baby bottle containing a desired liquid adjacently underneath the bottle support member 10. The user will then encircle the baby bottle with the retaining straps 30 in order to secure the baby bottle to the bottle support member 10. The user will then attach the baby bottle holder 100 to the arm 310 of the infant car seat 300 using the attachment member 50 to suspend the baby bottle holder 100 from the carrier arm of an infant car seat in the desired feeding position.

The user then secures the baby bottle holder 100 to the infant car seat carrier arm using the fastener 60. The second end of the fastener 60 is wrapped around the infant car seat carrier handle to surroundably secure the attachment member 50 to the infant car seat carrier arm. The user can then place if desired a small toy on the hook 45 for the child's entertainment.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An apparatus for holding a baby bottle comprising:
a bottle support member, said bottle support member being configured to receive said baby bottle thereon;
a support arm, said support arm having a first end being connected with said bottle support member; and
a attachment member, said attachment member extending from a second end of said support arm, said attachment member for attaching the apparatus to a carrier arm of an infant seat.

2. The apparatus as recited in claim 1, wherein said bottle support member is configured to mate with said baby bottle.

3. The apparatus as recited in claim 2, wherein said bottle support member including at least one aperture.

4. The apparatus as recited in claim 3, and further including at least one strap for releasably securing said baby bottle to said bottle support member, said strap being journaled through said aperture.

5. The apparatus as recited in claim 4, wherein said attachment member at least including a fastener, said fastener operable to secure said attachment member to the carrier arm of the infant car seat.

6. The apparatus as recited in claim 5, and further including a hook, said hook adjacent said attachment member for attaching of a child's toy.

7. The apparatus as recited in claim 6, and further comprising a keeper, said keeper extending from said hook, said keeper for receiving an item thereon.

8. An apparatus for holding a baby bottle comprising:
a bottle support member, said bottle support member being configured to receive the baby bottle thereon;
a support arm, said support arm having a first end and a second end, said first end being contiguous with said bottle support member; and
a attachment member, said attachment member being integrally formed with said second end of said support arm, said attachment member being generally arcuate in shape for attaching said apparatus to a carrier arm of an infant car seat.

9. The apparatus as recited in claim 8, wherein said bottle support member is rectangular and concave in shape for meshing with said baby bottle, said bottle support member being 6 inches in length and 1.5 inches wide.

10. The apparatus as recited in claim 9, and further including at least 4 slots proximate to a edge of said bottle support member, said at least 4 slots being positioned in pairs on opposing sides of said bottle support member.

11. The apparatus as recited in claim 10, and further including 2 straps for releasably securing said baby bottle to said bottle support member, said straps being journaled through said slots.

12. The apparatus as recited in claim 11, and further including a fastener having a first end integrated with said attachment member and a second end for surroundably securing said attachment member to said carrier arm.

13. The apparatus as recited in claim 12, and further including a hook, said hook having a first end and a second end, said first end being adjacent to and substantially perpendicular to said attachment member, said hook for receiving a toy.

14. The apparatus as recited in claim 13, and further including a keeper contiguous to said second end of said hook, said keeper being generally round in shape, said keeper for retaining said child's toy on said hook.

15. The apparatus as recited in claim 14, wherein said apparatus is manufactured from plastic.

16. An apparatus for holding a baby bottle comprising:
a bottle support member, said bottle support member being generally rectangular and concave in shape for receiving said baby bottle thereon;
a support arm, said support arm having a first end and a second end, said first end being contiguous and generally perpendicular with said bottle support member;
a attachment member, said attachment member being integrally formed with said second end of said support arm, said attachment member being generally arcuate in shape for attaching said apparatus to a carrier arm of an infant car seat
a fastener, said fastener having a first end and a second end, said first end of said fastener being secured to said attachment member, said second end for releasbly securing said attachment member to said carrier arm; and
a hook, said hook being integrally attached and generally perpendicular with said attachment member.

17. The apparatus as recited in claim 16, and further comprising 4 slots, said slots being positioned parallel in pairs on opposite sides of said bottle support member for receipt therein of 2 straps, said straps releasably securing said baby bottle to said bottle support member.

18. The apparatus as recited in claim 17, wherein said apparatus is manufactured from plastic.

19. The apparatus as recited in claim 18, wherein said fastener and said strap are Hook/loop fastener straps.

20. The apparatus as recited in claim 19, wherein said support arm is 7 inches in length.
